(19) United States
(12) Patent Application Publication
(10) Pub. No.: US 2011/0092326 A1
(43) Pub. Date: Apr. 21, 2011

(54) PULLEY FOR USE WITH TOOTHED BELT

(75) Inventors: Masaru KANAMORI, Osaka (JP); Masato TOMOBUCHI, Osaka (JP)

(73) Assignee: TSUBAKIMOTO CHAIN CO., Osaka (JP)

(21) Appl. No.: 12/893,543

(22) Filed: Sep. 29, 2010

(30) Foreign Application Priority Data
Oct. 15, 2009 (JP) 2009-238073

(51) Int. Cl. F16H 55/10

(52) U.S. Cl. 474/152

(57) ABSTRACT

The invention provides a toothed-belt pulley that is capable of reducing pneumatic and plosive sounds and of reducing engagement noises while stably transmitting rotational movements by suppressing widthwise wobbling of a toothed belt and while reducing a manufacturing cost of the pulley by simplifying its manufacturing process and of improving a production yield by shortening its manufacturing time. The toothed-belt pulley has a disk whose inner circumference is fittingly attached to a rotary shaft and which is provided with teeth to be engaged with the toothed belt around the outer circumference and flanges erected on the both outer sides of the toothed belt, wherein each of the teeth has a concaved recess with which the toothed belt deformably engages in the widthwise center part thereof.

### CROSS REFERENCE TO RELATED APPLICATIONS

This application claims the foreign priority benefit under Title 35, United States Code, §119 (a)-(d) of Japanese Patent Application No. 2009-238073, filed on Oct. 15, 2009 in the Japan Patent Office, the disclosure of which is herein incorporated by reference in its entirety.

### BACKGROUND OF THE INVENTION

1. Field of the Invention

The present invention relates to a pulley for use with a toothed belt, which is referred to hereinafter as a ‘toothed-belt pulley,’ the toothed-belt pulley for engaging with the toothed belt to transmit rotational movements.

2. Related Art

Various toothed-belt pulley systems are currently known in the art. The toothed-belt pulleys have teeth which are engaged with a toothed belt around the outer circumference thereof and flanges erected on the both outer sides of the toothed belt. One example of one such system is disclosed in page 4 and FIG. 3 of Japanese Patent Application Laid-open No. 2001-276939.

As shown in FIG. 13, known toothed-belt pulleys 500 have the flanges 520 erected on the both sides of the teeth 511 that engage with the toothed belt. While the flanges 520 suppress widthwise wobbling of the toothed belt and thus allow rotational movements to be transmitted stably, the pulley 500 has a problem that it generates very large pneumatic and plosive sounds because air compressed when the pulley 500 engages with the toothed belt is effluent only through pathways of slight gaps between the sides of the toothed belt and the flanges 520.

Another known toothed-belt pulley that reduces such pneumatic and plosive sounds otherwise generated when the compressed air leaks from the gaps by letting the air out before the toothed-belt pulley engages with the toothed belt is disclosed in pages 3-5 and FIGS. 1-3 of Japanese Utility Model Application No. S61-178303.

As shown in FIGS. 14 through 16, this known toothed-belt pulley 600 reduces such pneumatic and plosive sounds otherwise generated by the compressed air that leaks from the gaps of the teeth 611 engaging with the toothed belt 650 to the right and left sides of the toothed-belt pulley 600 by forming circumferential cuts 612 in the teeth 611 which engage with the toothed belt 650. The circumferential cuts 612 let the air out in the direction from the cuts 612 to teeth bottom portions 613 before the toothed-belt pulley engages with the toothed belt.

Although it is conceivable to make such circumferential cuts 612 in the teeth 611 of the known toothed-belt pulley 600 to alleviate the problem of the large pneumatic and plosive sounds of the known toothed-belt pulley 500, the known toothed-belt pulley 600 has problems that because the circumferential cuts 612 whose depth is substantially equal to the overall height of the teeth 611 have to be made by means of cutting works or the like, its manufacturing cost rises due to a prolonged manufacturing process and its production yield drops due to a prolonged manufacturing time.

Still more, the known pulley 600 has another problem that its noise reducing effect is low because an amount of the released air is limited as the width of the cut 612 is narrow and the depth of the cuts 612 is limited by the height of the tooth 611 and because it is unable to prevent the engagement sound generated when the teeth 611 tightly contact with the toothed belt 650.

### BRIEF SUMMARY OF THE INVENTION

Accordingly, the present invention aims at solving the aforementioned prior art problems by providing a toothed-belt pulley whose manufacturing cost may be reduced by simplifying its manufacturing process, whose production yield may be improved by shortening its manufacturing time, which permits to transmit rotational movements stably by suppressing widthwise wobbling of a toothed belt and whose noise is lowered by reducing pneumatic and plosive sounds and engagement noises.

A first aspect of the invention aims at solving the aforementioned problems by providing a toothed-belt pulley having a disk whose inner circumference is fittingly attached to a rotary shaft and which has teeth to be engaged with a toothed belt around the outer circumference and flanges erected on the both outer sides of the toothed belt, wherein each of the teeth has a concaved recess with which the toothed belt deformably engages in the widthwise center part of the teeth.

The toothed-belt pulley of the first aspect of the invention has such advantageous effects that because it is possible to reduce pneumatic and plosive sounds otherwise generated and leaked when the air is compressed when the pulley engages with the toothed belt by discharging the compressed air from the recesses while stably transmitting rotational movements by suppressing the widthwise wobbling of the toothed belt by the flanges.

Still more, because the toothed belt deformably engages with the teeth of the pulley, the toothed belt will not tightly contact with the teeth, leave the spaces and thus reduce the engagement noise when it engages with the pulley. Furthermore, because the recess may be shallow, the disk may be formed while having the recess from the beginning or the recess may be formed only by a very small amount of cutting works. Accordingly, it is possible to reduce a manufacturing cost of the pulley by simplifying its manufacturing process and to improve a production yield by shortening its manufacturing time.

### BRIEF DESCRIPTION OF DRAWINGS

FIG. 1 is a perspective view showing a mode of use of a toothed-belt pulley of the invention;

FIG. 2 is a section view of the toothed-belt pulley of a first embodiment of the invention;

FIG. 3 is a perspective view of a tooth of the toothed-belt pulley of the first embodiment of the invention;

FIG. 4 is a section view of the toothed-belt pulley shown in FIG. 2 in a state engaged with a toothed belt;

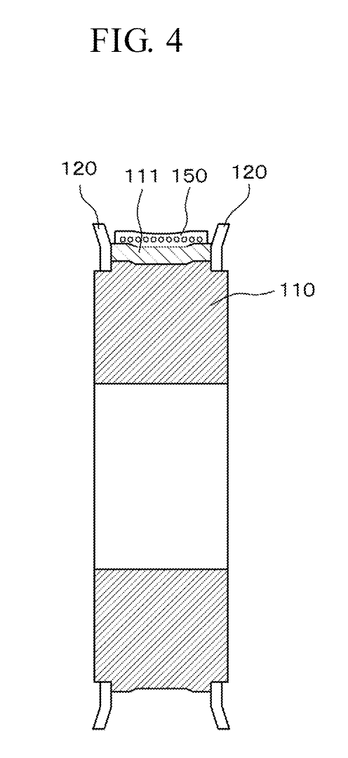

FIG. 5 is an enlarged view of a part of the toothed-belt pulley shown in FIG. 4;

FIG. 6 is a perspective view of the part of the toothed-belt pulley shown in FIG. 4;

FIG. 7 is a section view of the toothed-belt pulley according to a second embodiment of the invention;

FIG. 8 is a perspective view of a tooth of the toothed-belt pulley of the second embodiment of the invention;

FIG. 9 is a section view of the toothed-belt pulley according to a third embodiment of the invention;

FIG. 10 is a perspective view of a tooth of the toothed-belt pulley of the third embodiment of the invention;

FIG. 11 is a side view of the toothed-belt pulley according to a fourth embodiment of the invention;

FIGS. 12A and 12B are graphs comparing characteristics of the toothed-belt pulleys of the invention with that of a prior art toothed-belt pulley;

FIG. 13 is a perspective view of the prior art toothed-belt pulley;

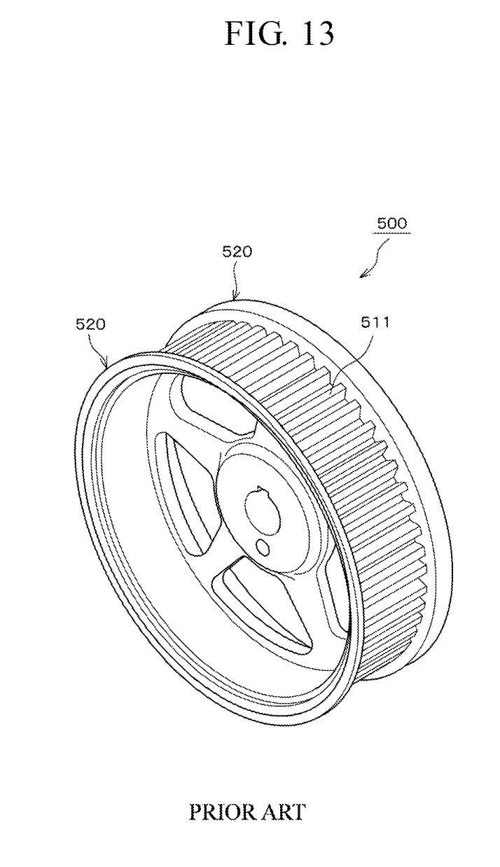

FIG. 14 is a side elevation view showing a mode of use of another prior art toothed-belt pulley;

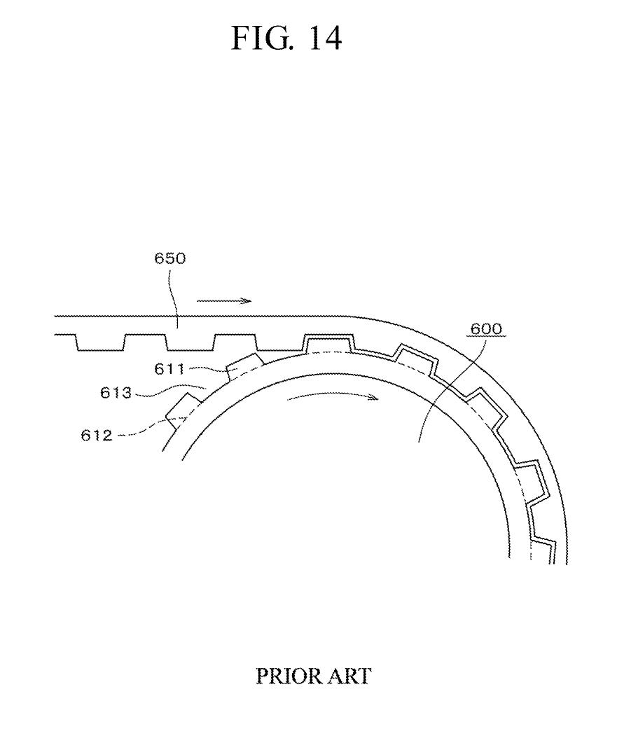

FIG. 15 is a front view of the other prior art toothed-belt pulley; and

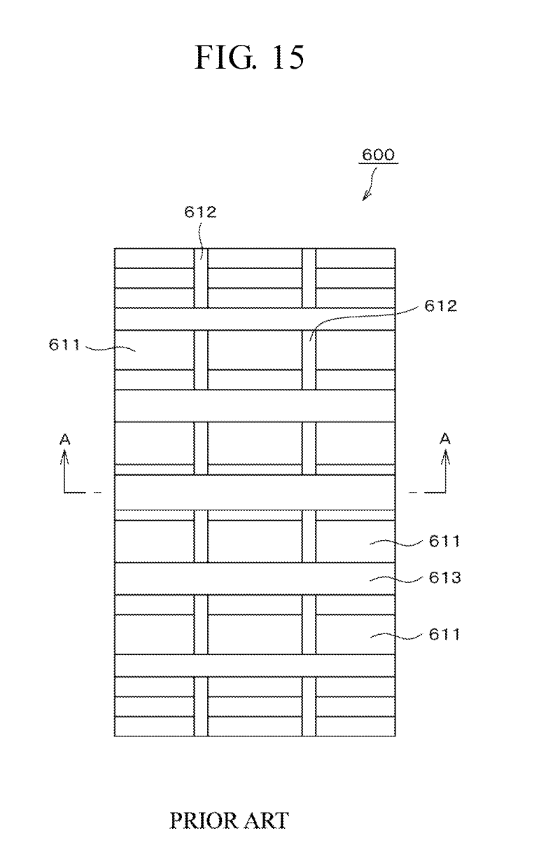

FIG. 16 is a section view showing a part of the other prior art toothed-belt pulley.

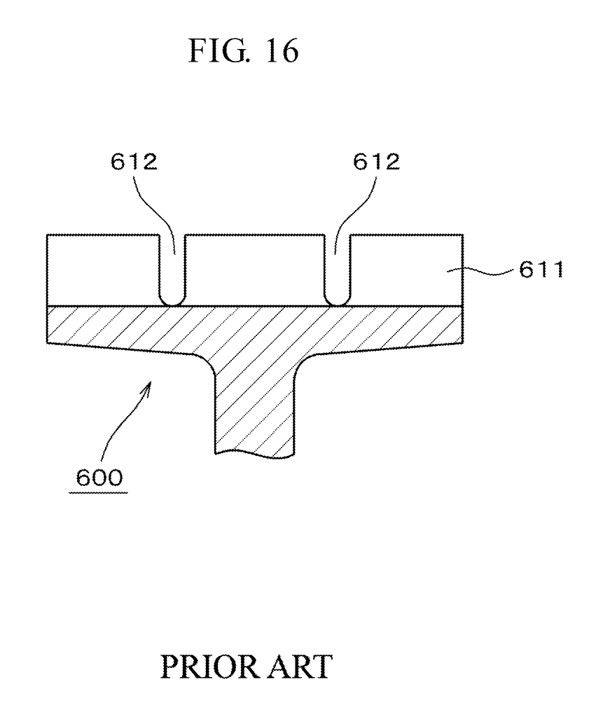

### BEST MODE FOR CARRYING OUT THE INVENTION

An embodiment of the toothed-belt pulley of the invention will be explained below with reference to the drawings.

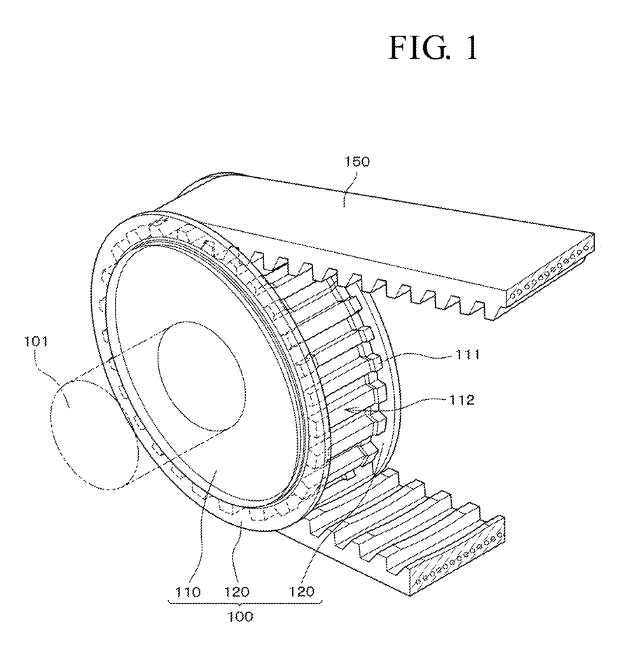

As shown in FIG. 1, the toothed-belt pulley 100 of the embodiment of the invention has a disk 110 that is provided with flanges 120 on the both sides of the outer peripheral portion thereof and teeth 111 on the outer circumference thereof. The disk 110 is fittingly attached to a rotary shaft 101 so that it transmits rotational movements by engaging the teeth 111 with a toothed belt 150.

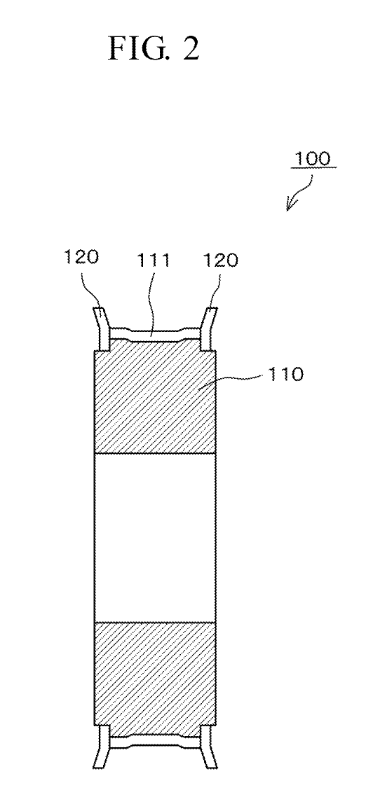

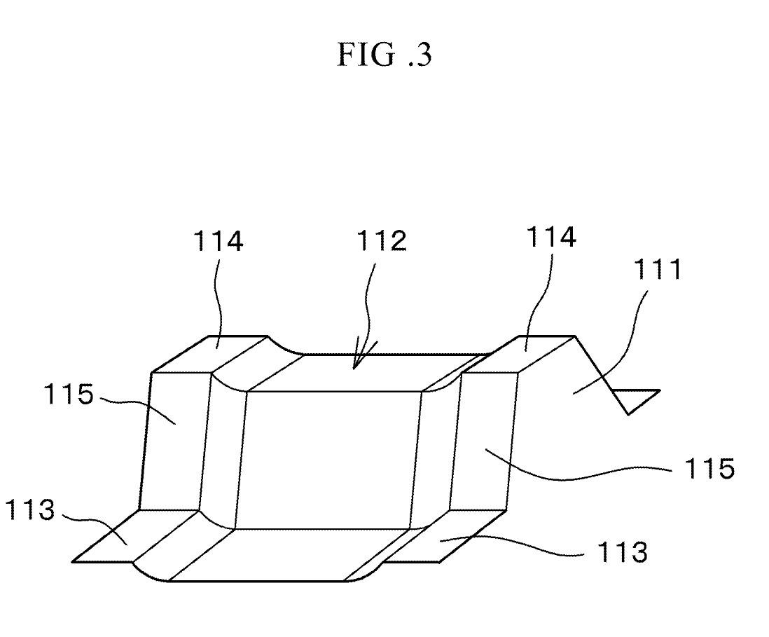

As shown in FIGS. 2 and 3, the toothed-belt pulley 100 of the first embodiment of the invention has the disk 110 provided with the flanges 120 on the both sides of the outer peripheral portion thereof and the teeth 111 that engage with the toothed belt 150 around the outer circumference of the disk 110. Each of the teeth 111 has a recess 112 in the widthwise central part thereof with a certain width and a certain depth from the surface thereof along the whole outer circumference of the disk 110 including tooth tip portions 114, tooth flank portions 115 and tooth bottom portions 113 of the teeth 111.

When the toothed belt 150 engages with this toothed-belt pulley 100, only the two end portions of the toothed belt 150 in the widthwise direction contact the tooth tip portion 114, while the tooth flank portion 115 and the tooth bottom portion 113 of the tooth 111 cause the central part of the toothed belt 150 to deflect in the direction of the center of rotation of the toothed-belt pulley 100 due to the recess 112.

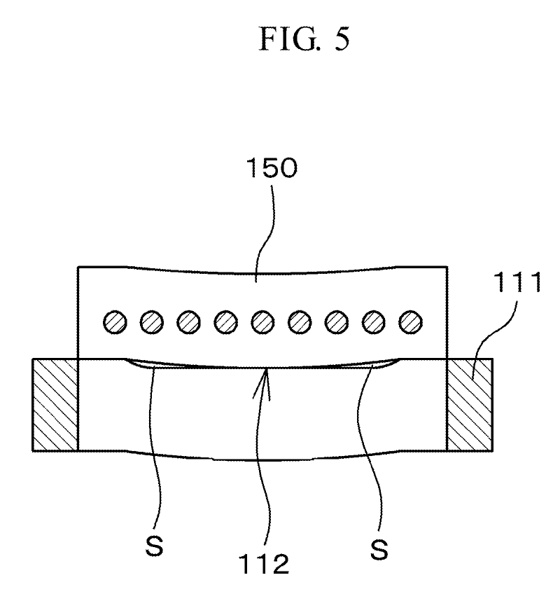

At this time, as shown in FIG. 5, while the toothed belt 150 deflects in arch and the part thereof near the central part contacts with the recess 112, spaces S are created between the recess 112 and the toothed belt 150 near the two ends of the recess 112.

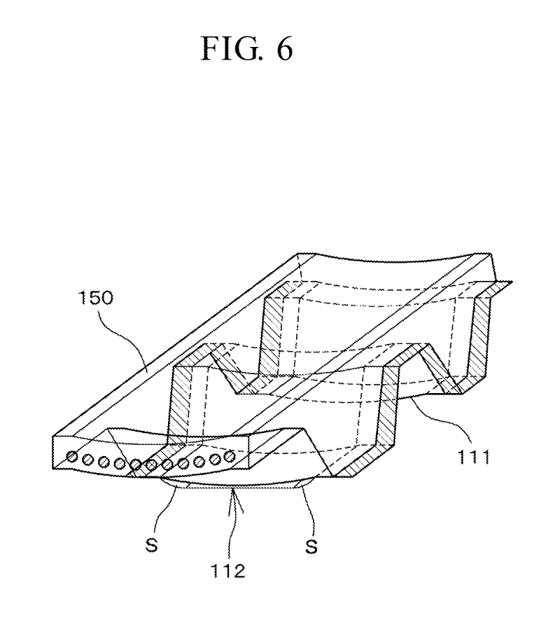

As shown in FIG. 6, the teeth of the toothed belt 150 are also deformed between the tooth flank portion 115 and the toothed belt 150, so that spaces that communicate with the spaces S are created at least near the both ends of the recess 112.

Thereby, the air compressed when the toothed-belt pulley 100 engages with the toothed belt 150 is discharged through the spaces S of the recess 112, so that it is possible to reduce the pneumatic and plosive sounds otherwise generated when the compressed air leaks out of the slight gap, other than the spaces S.

Still more, because the toothed belt 150 deformably engages with the teeth without tightly contacting with them and the spaces S are also created, the engagement noise may be reduced without completely discharging the compressed air. The spaces S created when the toothed belt 150 engages with the teeth also communicate in the circumferential direction of the disk, so that the compressed air is more readily discharged, allowing the pneumatic and plosive sounds to be reduced more.

Furthermore, because the recess 112 may be shallow, the disk 110 may be formed while having the recess 112 from the beginning or the recess 112 may be formed only a very small amount of cutting works. Accordingly, its simplified manufacturing process permits to reduce a manufacturing cost and its shortened manufacturing time permits to improve a production yield.

### Second Embodiment

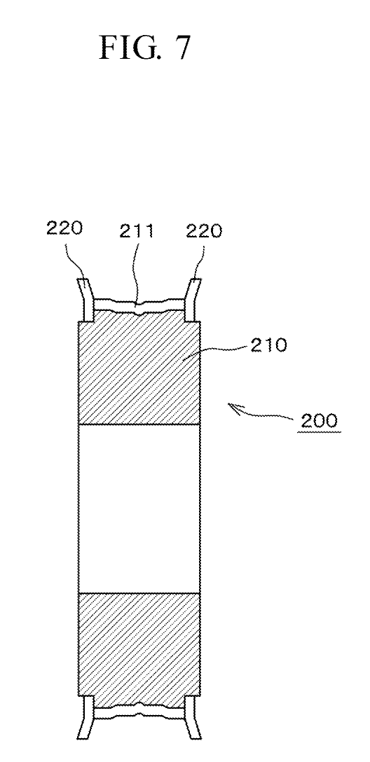

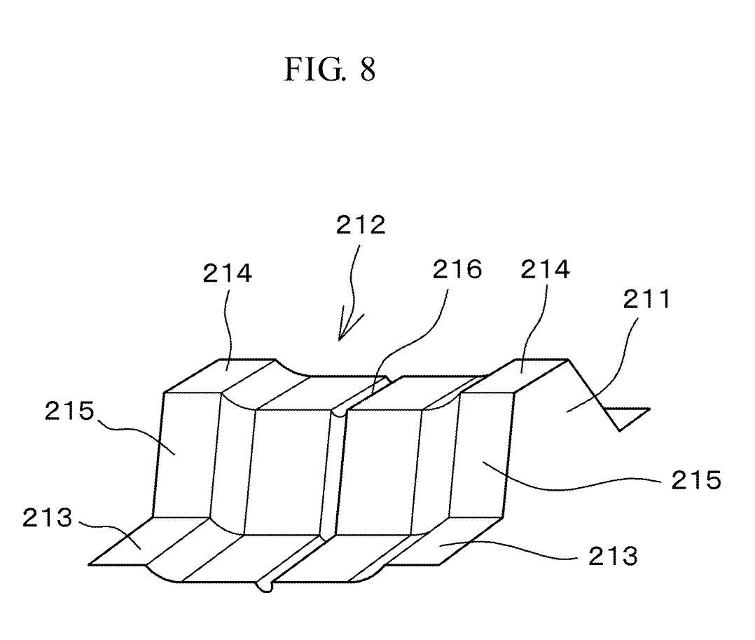

As shown in FIGS. 7 and 8, a toothed-belt pulley 200 of a second embodiment of the invention has a disk 210 provided with flanges 220 on the both sides of the outer peripheral portion thereof and teeth 211 that engage with a toothed belt around the outer circumference thereof. The teeth 211 have recesses 212 formed while having a certain depth from the surface thereof in the widthwise central part along the whole circumference of the disk 210 including tooth tip portions 214, tooth flank portions 215 and tooth bottom portions 213 of the teeth 211. The teeth 211 also have a concave recess groove 216 that is deeper than the recess 212 in the widthwise central part of the recess 212 along the whole circumference of the disk 210.

Thereby, a space is created by the recess groove 216 beside the spaces created near the both ends of the recess 212 and the air compressed when the toothed-belt pulley 200 engages with the toothed belt is discharged more out of the spaces of the recess 212 and the recess groove 216, so that it is possible to reduce the pneumatic and plosive sounds otherwise generated when the compressed air leaks out of the slight gap other than the spaces and to reduce the engagement noise more.

It is noted that the disk may be provided with a plurality of recess grooves 216 and may be provided along the whole circumference thereof or only in the tooth portions.

### Third Embodiment

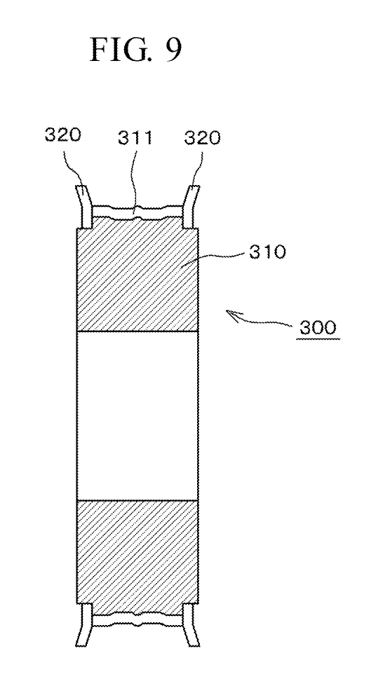

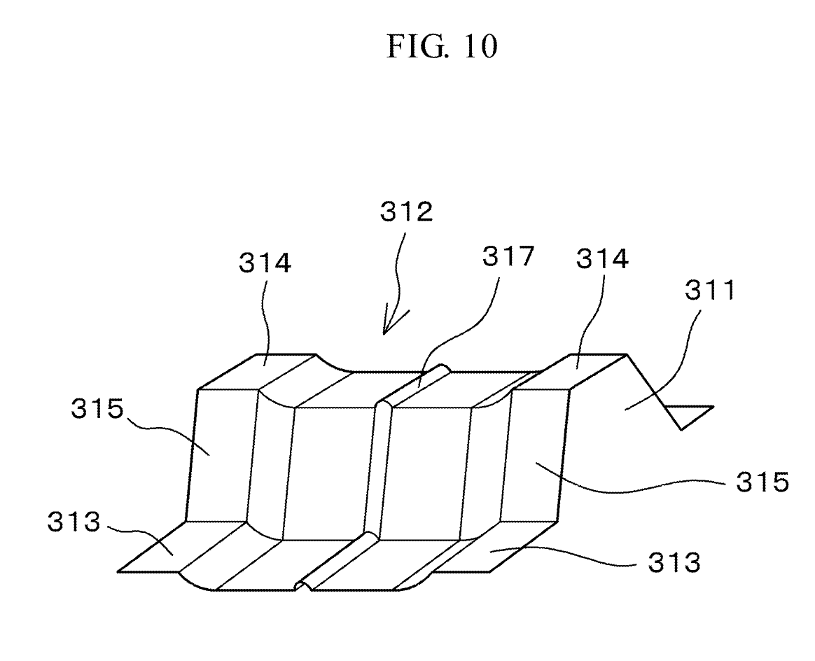

As shown in FIGS. 9 and 10, a toothed-belt pulley 300 of a third embodiment of the invention has a disk 310 provided with flanges 320 on the both sides of the outer peripheral portion thereof and teeth 311 that engage with a toothed belt around the outer circumference thereof. The teeth 311 have recesses 313 formed while having a certain depth from the surface thereof in the widthwise central part along the whole circumference of the disk 310 including tooth tip portions 314, tooth flank portions 315 and tooth bottom portions 313 of the teeth 311 and also have projecting portion 317 in the widthwise central part of the recess 312 along the whole circumference of the disk 310.

Thereby, spaces are created on the both sides of the projecting portion 317 because the toothed belt contacts with the projecting portion 317 formed in the widthwise central part of the recess 312 even if the toothed belt deflects in arch and the spaces created near the both ends of the recess 312 are enlarged, so that the air compressed when the toothed-belt pulley 300 engages with the toothed belt is discharged more out of the spaces. Accordingly, it is possible to reduce the pneumatic and plosive sounds otherwise generated when the compressed air leaks through the slight gap other than the spaces and to reduce the engagement noise more.

It is noted that the disk may be provided with a plurality of projecting portions 317 and may be provided along the whole circumference thereof or only at tooth tip portions 314, tooth flank portions 315 and tooth bottom portions 313.

### Fourth Embodiment

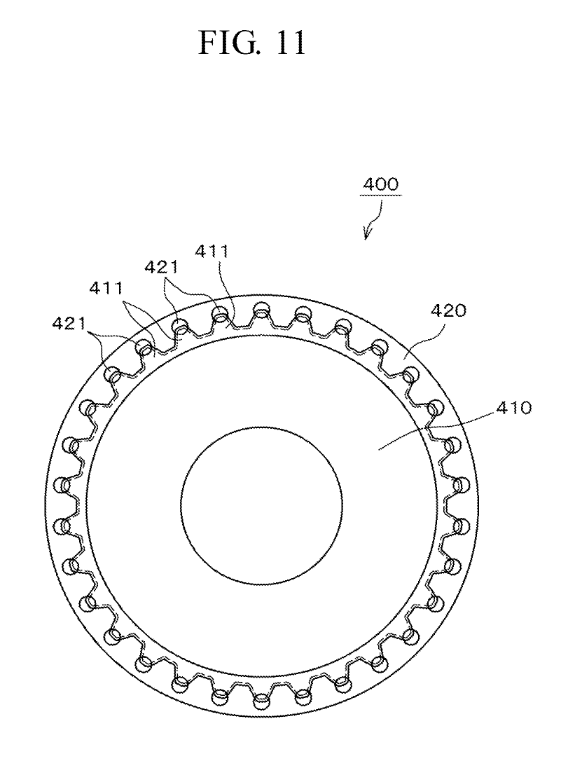

As shown in FIG. 11, a toothed-belt pulley 400 of a fourth embodiment of the invention has a disk 410 provided with flanges 420 on the both sides of the outer peripheral portion thereof and with teeth 411 that are to be engaged with a toothed belt on the outer circumference. The teeth 411 have recesses formed in the widthwise central part of the teeth in the same manner with the first through third embodiments and the flanges 420 have through holes 421 penetrating therethrough at positions corresponding to the tooth tips of the respective teeth 411.

Thereby, the air compressed when the teeth of the pulley engage with the toothed belt and discharged in the direction of the flanges is discharged through the through holes 421 while being suppressed to increase its pressure and flow rate, it is possible to reduce the pneumatic and plosive sounds otherwise generated when the compressed air leaks out of the slight gap between the toothed belt and the flange 420.

It is noted that the through holes 421 may be provided in any size and shape.

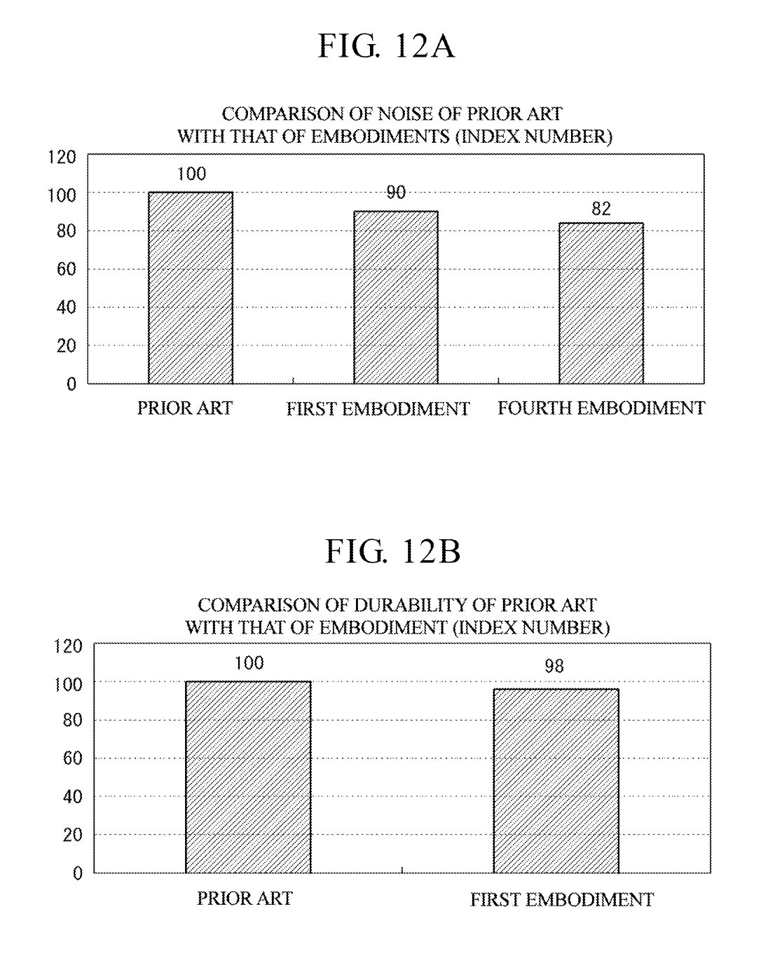

According to the invention, the noises may be reduced by about 10% by the toothed-belt pulley 100 of the first embodiment and by about 18% by the toothed-belt pulley 400 of the fourth embodiment as compared with the prior art toothed-belt pulley as shown in FIGS. 12A and 12B, so that the effect of the invention is remarkable.

A drop of durability involved in the deformation of the toothed belt is only 2% in the toothed-belt pulley 100 of the first embodiment of the invention as compared with that of the prior art toothed-belt pulley. That is, it is substantially negligible.

As described above, the invention brings about the remarkable advantageous effects of providing the toothed-belt pulley whose manufacturing cost may be reduced by simplifying its manufacturing process, whose production yield may be improved by shortening the manufacturing time, which permits to transmit rotational movements stably by suppressing widthwise wobbling of the toothed belt and whose noises are reduced by reducing the pneumatic and plosive sounds and the engagement noise.

### Other Embodiments

Although the invention is described above using examples, the specific scope and meaning of the claims are not limited to the examples described above. Rather, the specific mode of a toothed-belt pulley of the present invention differ, as illustrated by the alternate embodiments described below.

For example, the material of the disk of the toothed-belt pulley of the invention may be any material such as metal like iron, resin, ceramics and others.

Still more, the recesses provided in the teeth of the toothed-belt pulley may be provided from the beginning in manufacturing the disk or may be formed afterward by means of cutting works and the like.

Still more, the flanges may be formed integrally with the disk. Or, flanges formed separately from the disk may be fittingly attached to the disk. Still more, one flange of the both flanges may be formed integrally with the disk and the other flange formed separately from the disk may be fittingly attached.

The flange may be fittingly attached to the disk by any process such as close fitting like press fitting and shrink fitting or may be fixed by means of bolts and nuts.

Still more, the disk of the toothed-belt pulley of the invention may be fittingly attached to the rotary shaft by any process such as close fitting, like press fitting and shrunk fitting or may be fixed by bolts and nuts. Still more, fitting way utilizing key grooves and splines may be used.

### DESCRIPTION OF REFERENCE NUMERALS

100, 200, 300, 400, 500, 600 toothed-belt pulley
101 rotary shaft
110, 210, 310 disk
111, 211, 311, 411, 511, 611 teeth
112, 212, 312 recess
612 cut
113, 213, 313, 613 tooth bottom portion
114, 214, 314 tooth tip portion
115, 215, 315 tooth flank portion
216 recess groove
317 projecting portion
120, 220, 320, 420, 520 flange
421 through hole
150, 650 toothed belt
S space

What is claimed is:

1. A toothed-belt pulley, comprising:
a disk whose inner circumference is fittingly attached to a rotary shaft and which includes:
teeth around a outer circumference thereof which are to be engaged with a toothed belt which is wound around the outer circumference; and
flanges erected on the both outer sides of the toothed belt;
wherein the teeth have a concaved recess portion formed in the center of the teeth in a widthwise direction with which said toothed belt deformably engages.

2. The toothed-belt pulley according to claim 1, wherein the teeth further include tooth tip portions, tooth flank portions formed at a predetermined width of the teeth in the widthwise direction and tooth bottom portions formed at a predetermined depth, and wherein the recess portion is formed in the tooth bottom portions, tooth tip portions, and tooth flank portions.

3. The toothed-belt pulley according to claim 1, wherein the recess portion comprises a projecting portion in part thereof.

4. The toothed-belt pulley according to claim 1, wherein the recess portion has a still deeper concaved recess groove in part thereof.

5. The toothed-belt pulley according to claim 1, wherein said flange comprises a plurality of through holes that penetrate through said flange in the direction of said rotary shaft.

6. The toothed-belt pulley according to claim 5, wherein said plurality of through holes are provided at positions corresponding to tips of the teeth of said disk.

7. A toothed-belt pulley, comprising:
a disk whose inner circumference is fittingly attached to a rotary shaft and with flanges erected on both sides of an outer circumference where a toothed belt is wound,
wherein the outer circumference of disk includes a plurality of teeth for engaging with the toothed belt, each tooth of the disk including:
tip portions which extend away from the outer circumference of the disk toward the toothed belt;
tooth bottom portions formed at a predetermined depth from the tip portions;
flank portions which connect the tip portions and the tooth bottom portions; and
a concave recess portion formed in the center of the teeth in the widthwise direction.

8. The toothed-belt pulley according to claim 7, wherein the recess portion comprises a projecting portion in part thereof.

9. The toothed-belt pulley according to claim 7, wherein the recess portion has a still deeper concaved recess groove in part thereof.

10. The toothed-belt pulley according to claim 7, wherein said flange comprises a plurality of through holes that penetrate through said flange in the direction of said rotary shaft.

11. The toothed-belt pulley according to claim 10, wherein said plurality of through holes are provided at positions corresponding to tips of the teeth of said disk.
